(19) United States
(12) Patent Application Publication
(10) Pub. No.: US 2022/0214231 A1
(43) Pub. Date: Jul. 7, 2022

(54) SYSTEM AND METHODS FOR ACCURATELY DETERMINING AIR TEMPERATURE

(71) Applicant: Lenovo (Singapore) Pte. Ltd., New Tech Park (SG)

(72) Inventors: Robert James Kapinos, Durham, NC (US); Scott Wentao Li, Cary, NC (US); Robert James Norton, JR., Raleigh, NC (US); Russell Speight VanBlon, Raleigh, NC (US)

(21) Appl. No.: 17/140,693

(22) Filed: Jan. 4, 2021

(51) Int. Cl. G01K 15/00; G01K 1/02; G01K 3/02; G01K 1/024

(52) U.S. Cl. CPC G01K 15/005; G01K 1/024; G01K 3/02; G01K 1/026

(57) ABSTRACT

A system, method, and computer program product include a temperature determination control unit in communication with a monitored temperature sensor within an environment and one or more checking temperature sensors within the environment. The temperature determination control unit is configured to receive a monitored air temperature from the monitored temperature sensor. The temperature determination control unit is configured to receive a checking air temperature from the one or more checking temperature sensors. The temperature determination control unit is configured to compare the monitored air temperature with the checking air temperature. The temperature determination control unit is configured to determine an accuracy of the monitored air temperature based on a comparison of the monitored air temperature with the checking air temperature.

### FIELD

The present disclosure relates generally to systems and methods for accurately determining air temperature, such as in an outdoor environment or an indoor environment.

### BACKGROUND OF THE INVENTION

Temperature sensors are used to detect air temperature at various locations. For example, a temperature sensor can be used to detect an air temperature in an outside environment. As another example, a temperature sensor can be used to detect an air temperature within an inside environment, such as within a residential or commercial building.

Certain temperature sensors can be subject to time variant transients and other environmental factors. For example, a meteorological temperature that is used to detect air temperature climate readings can be subjected to direct sunlight at certain times of day, and shade at other times of day. When in the shade, the temperature sensor may output a temperature reading that may be cooler than the actual air temperature. As another example, wind can affect the temperature sensor. The wind can cause convective cooling that can also lead to an inaccurate temperature reading.

Further, a temperature sensor within a building can be affected by various factors. For example, the temperature sensor can be located proximate to a heater, blower, or the like, which, when activated, can affect the temperature surrounding the temperature sensor. As such, the temperature sensor can output a temperature reading that can be inaccurate due to operation of one or more components proximate to the temperature sensor.

In general, temperature sensors can be affected by environmental factors, such as direct sunlight, shade, wind, precipitation, and the like. Ideally, an environment monitoring temperature sensor, for example, should be out of line of radiant heating, protected from wind chill, and isolated from heated buildings. Moreover, many, if not all, temperature sensors drift in calibration over time.

Accordingly, a need exists for a system and method of accurately determining and confirming air temperature as detected by a temperature sensor.

### SUMMARY

In accordance with embodiments herein, a system includes a temperature determination control unit in communication with a monitored temperature sensor within an environment and one or more checking temperature sensors within the environment. The temperature determination control unit is configured to receive a monitored air temperature from the monitored temperature sensor. The temperature determination control unit is configured to receive a checking air temperature from the one or more checking temperature sensors. The temperature determination control unit is configured to compare the monitored air temperature with the checking air temperature. The temperature determination control unit is configured to determine an accuracy of the monitored air temperature based on a comparison of the monitored air temperature with the checking air temperature.

In at least one embodiment, the environment is an outside environment. In at least one other embodiment, the environment is an inside environment.

In an example, the one or more checking temperature sensors include a plurality of checking temperature sensors. In a further example, the temperature determination control unit is configured to determine the checking air temperature as an average or mean of a plurality of checking air temperatures as detected by the plurality of checking temperature sensors.

In at least one embodiment, the one or more checking temperature sensors are within a predetermined range of the monitored temperature sensor. For example, the predetermined range is within 300 feet of the monitored temperature.

In an example, one or both of the monitored temperature sensor or the one or more checking temperature sensors are in direct communication with the temperature determination control unit. In another example, one or both of the monitored temperature sensor or the one or more checking temperature sensors are in indirection communication with the temperature determination control unit through a network.

In at least one embodiment, the temperature determination control unit is configured to determine the accuracy of the monitored air temperature based on the comparison of the monitored air temperature with the checking air temperature in relation to a predetermined error threshold.

In at least one embodiment, the temperature determination control unit is further configured to calibrate the monitored temperature sensor in response to a difference between the monitored air temperature and the checking air temperature exceeding a predetermined error threshold.

In at least one embodiment, the temperature determination control unit identifies one or both of the monitored air temperature sensor or the one or more checking air temperature sensors as inaccurate.

Certain embodiments provide a method including under control of one or more processors configured with executable instructions, receiving a monitored air temperature from a monitored temperature sensor; receiving a checking air temperature from one or more checking temperature sensors; comparing the monitored air temperature with the checking air temperature; and determining an accuracy of the monitored air temperature from said comparing.

In an example, the one or more checking temperature sensors include a plurality of checking temperature sensors, and the method further includes determining the checking air temperature as an average or mean of a plurality of checking air temperatures as detected by the plurality of checking temperature sensors.

In at least one embodiment, the method includes disposing the one or more checking temperatures within a predetermined range of the monitored temperature sensor.

In at least one embodiment, the method include directly communicatively coupling one or both of the monitored temperature sensor or the one or more checking temperature sensors with the temperature determination control unit. As another example, the method include indirectly communicatively coupling one or both of the monitored temperature sensor or the one or more checking temperature sensors with the temperature determination control unit through a network.

In at least one example, said determining includes determining the accuracy of the monitored air temperature based on the comparison of the monitored air temperature with the checking air temperature in relation to a predetermined error threshold.

In at least one embodiment, the method also includes calibrating the monitored temperature sensor in response to a difference between the monitored air temperature and the checking air temperature exceeding a predetermined error threshold.

Certain embodiments provide a computer program product including a non-signal computer readable storage medium including computer executable code to: receive a monitored air temperature from a monitored temperature sensor; receive a checking air temperature from one or more checking temperature sensors; compare the monitored air temperature with the checking air temperature; and determine an accuracy of the monitored air temperature from a comparison of the monitored air temperature with the checking air temperature.

### BRIEF DESCRIPTION OF THE DRAWINGS

FIG. 1 illustrates a schematic diagram of a system for determining an air temperature in accordance with embodiments herein.

FIG. 2 illustrates a flow chart of a method for determining an air temperature in accordance with embodiments herein.

FIG. 3 illustrates a simplified block diagram of a device in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

The term “temperature sensor” refers to a device that is configured to detect a temperature. For example, the temperature sensor is configured to detect an air temperature surrounding the temperature sensor. The temperature sensor can be a thermometer, thermostat, or the like. The temperature sensor can be a meteorological grade temperature sensor. As another example, the temperature sensor can be a commercial grade temperature sensor. The temperature sensor can be an electronic temperature sensor that is configured to detect a temperature and output temperature data indicative of the detected temperature, such as via a communication device (for example, an antenna, wired connection, and/or the like). As another example, the temperature can be an analog temperature sensor, such as a mercury-based temperature sensor. Such a temperature sensor can be coupled to an electronic device that is configured to output temperature data indicative of the detected temperature.

The term “monitored temperature sensor” is a temperature sensor that is being monitored. For example, the monitored temperature sensor detects air temperature and outputs temperature data indicative of the air temperature to be used for climate readings, building control readings, or the like. The monitored temperature sensor can be a dedicated temperature sensor that is mounted to a structure, such as a building, pole, or the like. The monitored temperature sensor can be outside or inside a structure, such as a building. Optionally, the monitored temperature can be a mobile temperature sensor that can be moved between locations. As an example, the monitored temperature sensor can be within a handheld device, such as a smart phone, tablet, or the like.

The term “monitored air temperature” is the air temperature as detected by the monitored temperature sensor.

The term “checking temperature sensor” is a temperature sensor that is used to detect air temperature to check the accuracy of the temperature data output by the monitored temperature sensor. The checking temperature sensor can be a dedicated temperature sensor that is mounted to a structure, such as a building, pole, or the like. The checking temperature sensor can be outside or inside a structure, such as a building. Optionally, the checking temperature can be a mobile temperature sensor that can be moved between locations. As an example, the checking temperature sensor can be within a handheld device, such as a smart phone, tablet, or the like.

The term “checking air temperature” is the air temperature as detected by one or more of the checking temperature sensors.

The term “environment” refers to a physical region in which one or more temperature sensors are located. By way of example, an environment may refer to an area outside of a building, one or more rooms within a home, office or other structure. An environment may or may not have physical boundaries.

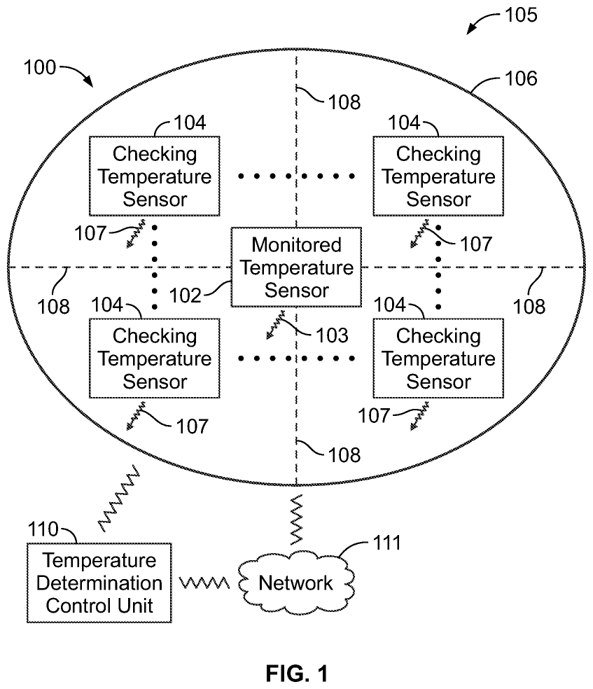

FIG. 1 illustrates a schematic diagram of a system 100 for determining an air temperature in accordance with embodiments herein. The system 100 includes a monitored temperature sensor 102, and one or more checking temperature sensors 104 within an environment 105. The environment 105 can be an outside environment, such as within a field, parking lot, street, open air stadium, or the like. Optionally, the environment 105 can an indoor environment, such as within a residential or commercial building.

In at least one embodiment, the monitored temperature sensor 102 is configured to detect air temperature and output temperature data indicated of the detected air temperature. The monitored temperature sensor 102 can be configured to detect air temperature for climate readings, building control readings, or the like.

In at least one embodiment, the checking temperature sensors 104 are fixed or mobile temperature sensors. As examples, the checking temperature sensors 104 can be temperature sensors within handheld devices (such as smart phones, smart tablets, or the like), vehicles (such as automobiles). As other example, the checking temperature sensors 104 can be fixed to structures, such as buildings, poles, or the like. The system 100 can include any number of checking temperature sensors 104. For example, the system 100 can include ten or less checking temperature sensors 104. As another example, the system 100 can include one hundred or more checking temperature sensors 104.

The checking temperature sensors 104 are within a predetermined range 106 of the monitored temperature sensor 102. In at least one embodiment, the predetermined range 106 is a predetermined radius 108 from the monitored temperature sensor 102. For example, the predetermined radius 108 is within 300 feet of the monitored temperature sensor 102. Optionally, the predetermined range 106 can be greater or less than 300 feet. The predetermined range 106 is selected to ensure that the temperature surrounding the monitored temperature sensor 102 and the checking temperature sensors 104 is the same or substantially the same (such as within less than 1 degree Fahrenheit (F)). For example, if the distance between a checking temperature sensor 104 and the monitored temperature sensor 102 is outside of the predetermined and is too great (such as more than 5 miles), the air temperature at the different locations can differ enough such that the checking temperature sensor 104 is unable to accurately provide a check in relation to the monitored temperature sensor 102.

The monitored temperature sensor 102 and the checking temperature sensors 104 are in communication with a temperature determination control unit 110. In at least one embodiment, the temperature determination control unit 110 includes one or more processors configured with executable instructions. The temperature determination control unit 110 is part of a computing device, such as a desktop or laptop computer, a handheld device, such as a smart phone or smart tablet, and/or the like.

The monitored temperature sensor 102 and the checking temperature sensors 104 can be in direct communication with the temperature determination control unit 110, such as through one or more wired or wireless connections. As another example, the monitored temperature sensor 102 can be in indirect communication with the temperature determination control unit 110, such as via an intermediate network. The checking temperature sensors 104, the monitored temperature sensor 102, and the temperature determination control unit 110 can communicates with each other over a network 111, such as through wireless transceivers. For example, the checking temperature sensors 104 can be in a peer-to-peer network, which is in communication with the temperature determination control unit 110. The checking temperature sensors 104 can communicate with the temperature determination control unit 110 through the Internet.

The monitored temperature sensor 102 can be subject to time variant transients over the course of a day. The time variant transients can include direct sunlight, shade, wind, precipitation, and the like. As such, the monitored temperature sensor 102 can detect air temperature that may be affected by the time variant transients, and may therefore not be entirely accurate. The checking temperature sensors 104 provide redundant temperature checks to determine the accuracy of the temperature data output by the monitored temperature sensor 102.

In operation, the monitored temperature sensor 102 detects an air temperature (that is, a monitored air temperature), and outputs monitored temperature data indicative of the air temperature detected by the monitored temperature sensor 102. The temperature determination control unit 110 receives the monitored temperature data output by the monitored temperature sensor 102, either directly from the monitored temperature sensor 102, indirectly from a network in communication with the monitored temperature sensor 102, or the like.

The checking temperature sensors 104 also detect the air temperature (that is, a checking air temperature), and output checking temperature data indicative of the air temperature detected by the checking temperature sensors 104. The temperature determination control unit 110 receives the checking temperature data output by the checking temperature sensors 104, either directly from the checking temperature sensors 104, indirectly from a network in communication with the checking temperature sensors 104, or the like.

The temperature determination control unit 110 compares the monitored temperature data and the checking temperature data to determine the accuracy of the air temperature detected by the monitored temperature sensor 102. If the monitored temperature data is within a predetermined error threshold of the checking temperature data, then the temperature determination control unit 110 determines that the temperature detected by the monitored temperature sensor 102 is accurate.

In at least one embodiment, the predetermined error threshold can be based on the precision of the checking temperature sensors 104. For example, the checking temperature sensors 104 can be precise within 2 degrees F. As such, the predetermined error threshold can be +/−2 degrees F. For example, if the monitored temperature data provides a temperature of 80 degrees F., and the checking temperature data provides a temperature of 79 degrees F., the temperature determination control unit 110 determines that the monitored temperature data is accurate. In response, the temperature determination control unit 110 can output an alert signal indicating that the temperature detected by the monitored temperature sensor 102 is accurate.

If, however, the monitored temperature data is outside of the predetermined threshold in relation to the checking temperature data, the temperature determination control unit 110 determines that the temperature detected by the monitored temperature sensor 102 is not accurate. The temperature determination control unit 110 can then output an alert signal indicating that the temperature detected by the monitored temperature sensor 102 is inaccurate. In at least one embodiment, the temperature determination control unit 110 can determine the difference between the temperature detected by the monitored temperature sensor 102 and the temperature detected by the checking temperature sensors 104, which may or may not account for the error threshold. The error signal can include the difference.

In at least one embodiment, the temperature determination control unit 110 flags or otherwise identifies inaccurate temperature sensors based on the analysis of the received data. For example, the temperature determination control unit 110 flags or otherwise identifies one or both of the monitored air temperature sensor 102 and/or one or more checking air temperature sensors 104 as inaccurate, based on the analyzed data, and outputs such information in the alert signal.

For example, if the monitored temperature sensor 102 detects an error temperature of 85 degrees F., and the checking temperature sensors 104 detect an error temperature of 75 degrees F., the temperature determination control unit 110 determines a difference between the monitored temperature sensor 102 and the checking temperature sensors 104 of 10 degrees (or 8 degrees, if the error threshold is +/−2 degrees F., for example). The difference represents a temperature anomaly as detected by the monitored temperature sensor 102. The alert signal can include the difference between the temperature as detected by the monitored temperature sensor 102 and the temperature as detected by checking temperature sensors 104.

In at least one embodiment, the temperature determination control unit 110 can calibrate the monitored temperature sensor 102 based on the difference between the temperature as detected by the monitored temperature sensor 102 and the temperature as detected by the checking temperature sensors 104. For example, the temperature determination control unit 110 calibrates the monitored temperature sensor 102 in response to a difference between the monitored air temperature and the checking air temperature exceeding the predetermined error threshold. The calibration can include a compensation for the predetermined error threshold. For example, if the monitored temperature sensor 102 detects a temperature that is 10 degrees F. higher than the temperature detected by the checking temperature sensors 104, the temperature determination control unit 110 can calibrate the monitored temperature sensor 102 by decreasing the temperature detected by the monitored temperature by the difference, compensating for the predetermined error threshold (in this example, 10 degrees F. minus the predetermined error threshold).

In at least one embodiment, the temperature determination control unit 110 determines the temperature as detected by the checking temperature sensors 104 as an average or a mean of the checking air temperatures as detected by the checking temperature sensors 104. If a checking temperature sensor 104 detects a checking air temperature that is outside a predetermined error threshold (such as +/−2 degrees F.) in relation to the checking air temperatures as detected by the other checking temperature sensors 104, the temperature determination control unit 110 can discard (for example, ignore) the checking air temperature air temperature that is outside the predetermined error threshold.

As described herein, the system 100 overcomes time and environmental limitations of temperature sensors. The system 100 is configured to aggregate temperatures as detected by a plurality of temperature sensors to provide an accuracy check for a monitored temperature sensor 102, as well as a process of calibrating the monitored temperature sensor 102.

The temperature determination control unit 110 analyzes temperature data from the monitored temperature sensor 102 and the checking temperature sensors 104 within the environment 105. The temperature determination control unit 110 can compile the temperature data into a land graph, for example, using the locations of the monitored temperature sensor 102 and the checking temperature sensors 104. The locations can be pre-programmed and known by the temperature determination control unit 110, and/or monitored and determined through position determining sub-systems, which can be in communication with the temperature determination control unit 110 and/or a network in communication with the temperature determination control unit 110. The land graph can be used to determine which, if any, of the monitored temperature sensor 102 and/or the checking temperature sensors 104 are being influenced by transient conditions, outside influence, or mis-calibration errors.

As described herein, the system 100 includes the temperature determination control unit 110 in communication with the monitored temperature sensor 102 and one or more checking temperature sensors 104. The temperature determination control unit 110 is configured to receive a monitored air temperature 103 from the monitored temperature sensor 102. For example, the monitored air temperature 103 is part of temperature data provided on a signal that is sent wirelessly or via a wired connection directly or indirectly to the temperature determination control unit 110. The temperature determination control unit is configured to also receive a checking air temperature 107 from the one or more checking temperature sensors 104. For example, the checking air temperature 103 is part of temperature data provided on a signal that is sent wirelessly or via a wired connection directly or indirectly to the temperature determination control unit 110. The temperature determination control unit 110 is configured to compare the monitored air temperature 103 with the checking air temperature 107. The temperature determination control unit 110 is configured to determine an accuracy of the monitored air temperature 103 based on a comparison of the monitored air temperature 103 with the checking air temperature 107.

As described herein, embodiments of the present disclosure provide a method including, under control of one or more processors configured with executable instructions, receiving a monitored air temperature 103 from the monitored temperature sensor 102; receiving a checking air temperature 107 from one or more checking temperature sensors 104; comparing the monitored air temperature 103 with the checking air temperature 107; and determining an accuracy of the monitored air temperature 103 from said comparing.

As described herein, embodiments of the present disclosure provide a computer program product including a non-signal computer readable storage medium including computer executable code to: receive a monitored air temperature 103 from the monitored temperature sensor 102; receive a checking air temperature 107 from one or more checking temperature sensors 104; compare the monitored air temperature 103 with the checking air temperature 107; and determine an accuracy of the monitored air temperature 103 from a comparison of the monitored air temperature 103 with the checking air temperature 107.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the temperature determination control unit 110 may be or include one or more processors that are configured to control operation, as described herein.

The temperature determination control unit 110 is configured to execute a set of instructions that are stored in one or more data storage units or elements (such as one or more memories), in order to process data. For example, the temperature determination control unit 110 may include or be coupled to one or more memories. The data storage units may also store data or other information as desired or needed. The data storage units may be in the form of an information source or a physical memory element within a processing machine.

The set of instructions may include various commands that instruct the temperature determination control unit 110 as a processing machine to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of embodiments herein may illustrate one or more control or processing units, such as the temperature determination control unit 110. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the temperature determination control unit 110 may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

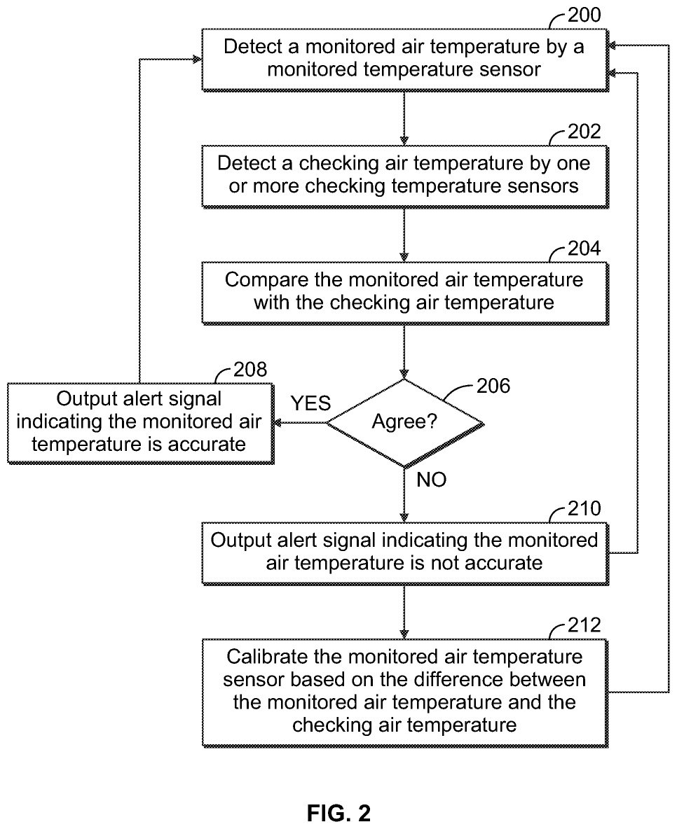

FIG. 2 illustrates a flow chart of a method for determining an air temperature in accordance with embodiments herein. Referring to FIGS. 1 and 2, the method includes detecting, at 200, a monitored air temperature by the monitored temperature sensor 102. At 202, a checking air temperature is detected by one or more checking temperature sensors 104.

At 204, the temperature determination control unit 110 compares the monitored air temperature with the checking air temperature. At 206, the temperature determination control unit 110 determines whether the monitored air temperature agrees with (for example, is the same and/or within a predetermined error threshold) the checking air temperature.

If, at 206, the temperature determination control unit 110 determines that the monitored air temperature agrees with the checking air temperature, the method proceeds to 208, at which the temperature determination control unit 110 outputs an alert signal (such as to a computing device that includes or is in communication with the temperature determination control unit 110) indicating that the monitored air temperature is accurate. The method then returns to 200.

If, however, at 206, the temperature determination control unit 110 determines that the monitored air temperature does not agree (for example, is not the same, and/or is outside of the predetermined error threshold), the method proceeds to 210, at which the temperature determination control unit 110 outputs an alert signal (such as to a computing device that includes or is in communication with the temperature determination control unit 110) indicating that the monitored air temperature is not accurate. The method may then return to 200.

Optionally, or additionally, the method may proceed from 210 to 212, at which the temperature determination control unit 110 calibrates the monitored temperature sensor based on the difference between the monitored air temperature and the checking air temperature. The method may then return to 200.

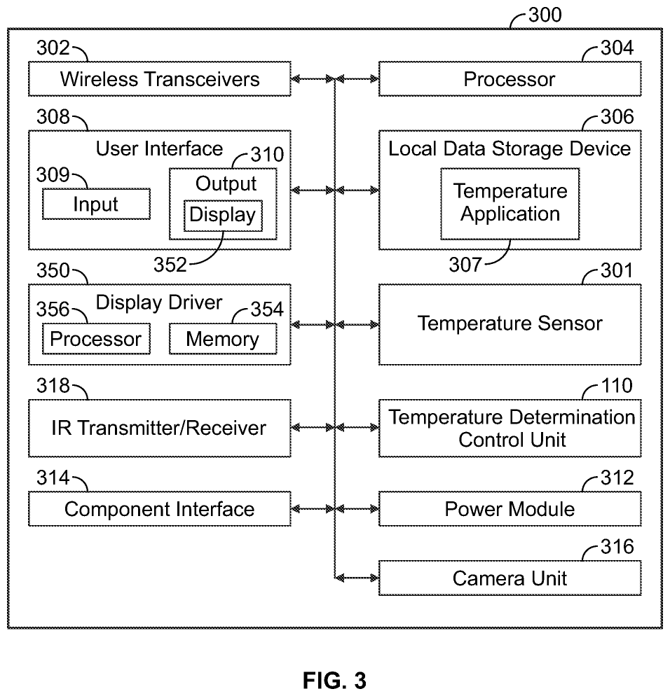

FIG. 3 illustrates a simplified block diagram of a device 300 in accordance with embodiments herein. The device 300 includes a temperature sensor 301. In at least one embodiment, the temperature sensor 301 is a checking temperature sensor 104 (shown in FIG. 1). In at least one embodiment, the temperature sensor 301 is the monitored temperature sensor 102 shown in FIG. 1. In at least one other embodiment, the checking temperature sensor 104 and/or the monitored temperature sensor 102 may not be within the device 300. For example, the checking temperature sensor 104 and/or the monitored temperature sensor 102 can be dedicated temperature sensors mounted to a fixed structure, such as a building, pole, bridge, wall, and/or the like. As another example, the checking temperature 104 and/or the monitored temperature 102 can be part of portable structures removably mounted or secured on or within other components.

In at least one embodiment, the device 300 includes the temperature determination control unit 110. For example, the device 300 includes the temperature determination control unit 110 and the temperature sensor 301. The device 300 can include the temperature determination control unit 110, but not the temperature sensor 301. In at least one other embodiment, the device 300 includes the temperature sensor 301, but not the temperature determination control unit 110.

The device 300 is a computing device. The device 300 can be a handheld device, such as a smart phone, smart tablet, or the like. In at least one other example, the device 300 can be a laptop computer, a desktop computer, or other such computing device.

The device 300 includes a housing with components such as one or more wireless transceivers 302, one or more processors 304 (e.g., a microprocessor, microcomputer, application-specific integrated circuit, etc.), one or more local data storage devices 306 (also referred to as a memory portion), a user interface 308 which includes one or more input devices 309 and one or more output devices 310, a power module 312, a component interface 314, a camera unit 316, the temperature sensor 301, and a display driver 350. All of these components can be operatively coupled to one another and can be in communication with one another by way of one or more internal communication links, such as an internal bus.

The user interface 308 permits a user to operate the base device 300 for any of its intended purposes, such as detecting an air temperature via the temperature sensor 301, operating software applications, electronic communication, capturing images with the camera unit 316, listening to audio media, viewing video media, and the like. To that end, the input and output devices 309, 310 may each include a variety of visual, audio, and/or mechanical devices. For example, the input devices 309 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 310 can include a visual output device such as a liquid crystal display screen 352, one or more light emitting diode indicators, an audio output device such as a speaker, alarm and/or buzzer, and a mechanical output device such as a vibrating mechanism. The display 352 may be touch sensitive to various types of touch and gestures. As further examples, the output device 310 may include a touch sensitive screen, a non-touch sensitive screen, a text-only display, a smart phone display, an audio output (e.g., a speaker or headphone jack), and/or any combination thereof.

The display driver 350 is coupled to the processor 304 and configured to manage display of content on the display 352. The display driver 350 is connected to primary and secondary viewing regions of the display 352. The display driver 350 writes the desired content to the primary and secondary viewing regions under direction of the main processor 304. Optionally, the display driver 350 includes display memory 354 and one or more display control processors 356. The display memory 354 includes multiple sections to which the display control processors 356 and/or processor 304 write content to be displayed. The sections of the display memory 354 are mapped to corresponding regions of a flexible display layer. The display driver 350 provides a common display interface for all of the viewing regions within the flexible display layer within the display 352. For example, the display driver 350 manages display of content in the primary and secondary viewing regions.

The local data storage device 306 can encompass one or more memory devices of any of a variety of forms (e.g., read only memory, random access memory, static random access memory, dynamic random access memory, etc.) and can be used by the processor 304 to store and retrieve data. The data that is stored by the local data storage device 306 can include, but need not be limited to, operating systems, applications, user collected content, and informational data. Each operating system includes executable code that controls basic functions of the device, such as interaction among the various components, communication with external devices via the wireless transceivers 302 and/or the component interface 314, and storage and retrieval of applications and data to and from the local data storage device 306. Each application includes executable code that utilizes an operating system to provide more specific functionality for the communication devices, such as file system service and handling of protected and unprotected data stored in the local data storage device 306.

The local data storage device 306 stores various content including, but not limited to, a temperature application 307 and control attributes. The temperature application 307 includes processes for detecting temperature via the temperature sensor 301, outputting temperature data indicative of the detected temperature, determining accuracy of a temperature data, and/or the like, as described herein. The temperature application 307 includes instructions accessible by the one or more processors 304 to direct the processor 304 to implement the methods, processes and operations described herein including, but not limited to, the methods, processes and operations illustrated in the Figures and described in connection with the Figures.

Other applications stored in the local data storage device 306 include various application program interfaces (APIs), some of which provide links to/from a cloud hosting service. The power module 312 preferably includes a power supply, such as a battery, for providing power to the other components while enabling the device 300 to be portable, as well as circuitry for the battery to be recharged. The component interface 314 provides a direct connection to other devices, auxiliary components, or accessories for additional or enhanced functionality, and in particular, can include a USB port for linking to a user device with a USB cable.

Each transceiver 302 can utilize a known wireless technology for communication. Exemplary operation of the wireless transceivers 302, in conjunction with other components of the base device 300, may take a variety of forms. For example, the wireless transceivers 302 may operate in a way which, upon reception of wireless signals, the components of the device 300 may detect communication signals from other devices and the transceiver 202 may demodulate the communication signals to recover incoming information. The processor 304 formats outgoing information and conveys the outgoing information to one or more of the wireless transceivers 302 for modulation to communication signals. The wireless transceivers 302 convey the modulated signals to a remote device, such as a cell tower or a remote server (not shown).

As described herein, embodiments of the present disclosure provide systems and methods for accurately determining and confirming air temperature as detected by a temperature sensor. Further, embodiments of the present disclosure provide systems and methods for calibrating temperature sensors.

Before concluding, it is to be understood that although e.g., a software application for undertaking embodiments herein may be vended with a device such as the system 100, embodiments herein apply in instances where such an application is e.g., downloaded from a server to a device over a network such as the Internet. Furthermore, embodiments herein apply in instances where e.g., such an application is included on a computer readable storage medium that is being vended and/or provided, where the computer readable storage medium is not a carrier wave or a signal per se.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the units/modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A system comprising:
a temperature determination control unit in communication with a monitored temperature sensor within an environment and one or more checking temperature sensors within the environment,
wherein the temperature determination control unit is configured to receive a monitored air temperature from the monitored temperature sensor,
wherein the temperature determination control unit is configured to receive a checking air temperature from the one or more checking temperature sensors,
wherein the temperature determination control unit is configured to compare the monitored air temperature with the checking air temperature, and
wherein the temperature determination control unit is configured to determine an accuracy of the monitored air temperature based on a comparison of the monitored air temperature with the checking air temperature.

2. The system of claim 1, wherein the environment is an outside environment.

3. The system of claim 1, wherein the environment is an inside environment.

4. The system of claim 1, wherein the one or more checking temperature sensors comprise a plurality of checking temperature sensors.

5. The system of claim 4, wherein the temperature determination control unit is configured to determine the checking air temperature as an average or mean of a plurality of checking air temperatures as detected by the plurality of checking temperature sensors.

6. The system of claim 1, wherein the one or more checking temperature sensors are within a predetermined range of the monitored temperature sensor.

7. The system of claim 6, wherein the predetermined range is within 300 feet of the monitored temperature.

8. The system of claim 1, wherein one or both of the monitored temperature sensor or the one or more checking temperature sensors are in direct communication with the temperature determination control unit.

9. The system of claim 1, wherein one or both of the monitored temperature sensor or the one or more checking temperature sensors are in indirection communication with the temperature determination control unit through a network.

10. The system of claim 1, wherein the temperature determination control unit is configured to determine the accuracy of the monitored air temperature based on the comparison of the monitored air temperature with the checking air temperature in relation to a predetermined error threshold.

11. The system of claim 1, wherein the temperature determination control unit identifies one or both of the monitored air temperature sensor or the one or more checking air temperature sensors as inaccurate.

12. The system of claim 1, wherein the temperature determination control unit is further configured to calibrate the monitored temperature sensor in response to a difference between the monitored air temperature and the checking air temperature exceeding a predetermined error threshold.

13. A method comprising:
under control of one or more processors configured with executable instructions,
receiving a monitored air temperature from a monitored temperature sensor;
receiving a checking air temperature from one or more checking temperature sensors;
comparing the monitored air temperature with the checking air temperature; and
determining an accuracy of the monitored air temperature from said comparing.

14. The method of claim 13, wherein the one or more checking temperature sensors comprise a plurality of checking temperature sensors, and wherein the method further comprises determining the checking air temperature as an average or mean of a plurality of checking air temperatures as detected by the plurality of checking temperature sensors.

15. The method of claim 13, further comprising disposing the one or more checking temperatures within a predetermined range of the monitored temperature sensor.

16. The method of claim 15, wherein the predetermined range is within 300 feet of the monitored temperature.

17. The method of claim 13, further comprising directly communicatively coupling one or both of the monitored temperature sensor or the one or more checking temperature sensors with the temperature determination control unit.

18. The method of claim 13, further comprising indirectly communicatively coupling one or both of the monitored temperature sensor or the one or more checking temperature sensors with the temperature determination control unit through a network.

19. The method of claim 13, wherein said determining comprises determining the accuracy of the monitored air temperature based on the comparison of the monitored air temperature with the checking air temperature in relation to a predetermined error threshold.

20. The method of claim 13, further comprising calibrating the monitored temperature sensor in response to a difference between the monitored air temperature and the checking air temperature exceeding a predetermined error threshold.

21. The method of claim 13, further comprising identifying, by the temperature determination control unit, one or both of the monitored air temperature sensor or the one or more checking air temperature sensors as inaccurate.

22. A computer program product including a non-signal computer readable storage medium including computer executable code to:
receive a monitored air temperature from a monitored temperature sensor;
receive a checking air temperature from one or more checking temperature sensors;
compare the monitored air temperature with the checking air temperature; and
determine an accuracy of the monitored air temperature from a comparison of the monitored air temperature with the checking air temperature.
